(19) United States
(12) Patent Application Publication
(10) Pub. No.: US 2018/0105724 A1
(43) Pub. Date: Apr. 19, 2018

(54) SEALING AGENT, LIQUID CRYSTAL PANEL, LIQUID CRYSTAL DISPLAY DEVICE AND FABRICATING METHOD THEREOF

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Zijing ZHANG, Beijing (CN); Wei LI, Beijing (CN); Dong LIANG, Beijing (CN); Kangdi ZHOU, Beijing (CN); Huishun CHEN, Beijing (CN); Qi ZHENG, Beijing (CN); Kaixuan WANG, Beijing (CN); Yao BI, Beijing (CN); Xiaoqing PENG, Beijing (CN); Hongliang YUAN, Beijing (CN); Li MA, Beijing (CN); Yang YOU, Beijing (CN); Xiaojuan WU, Beijing (CN); Shaowu MA, Beijing (CN)

(73) Assignees: Boe Technology Group Co., Ltd., Beijing (CN); Beijing Boe Optoelectronics Technology Co., Ltd., Beijing (CN)

(21) Appl. No.: 15/506,122

(22) PCT Filed: May 12, 2016
(86) PCT No.: PCT/CN2016/081833

§ 371 Date: Feb. 23, 2017

(30) Foreign Application Priority Data
Feb. 3, 2016 (CN) 201610076774.1

(51) Int. Cl. C09J 9/02; C09J 133/00; C09J 11/04; C09J 5/00; G02F 1/1339

(52) U.S. Cl. CPC C09J 9/02; C09J 133/00; C09J 2400/10; C09J 5/00; G02F 1/1339; C09J 11/04

(57) ABSTRACT

The present disclosure discloses a sealing agent, a liquid crystal panel, a liquid crystal display device, and a fabricating method thereof. The sealing agent comprises a sealing agent matrix and graphene oxide. The graphene oxide not only functions to support substrates and enable electrical conduction, but also effectively prevents the phenomenon of liquid crystal molecules penetration from occurring. In this way, a liquid crystal panel which is prepared with the sealing agent as a bonding agent has excellent display effect.

### RELATED APPLICATIONS

The present application is the U.S. national phase entry of PCT/CN2016/081833, with an international filing date of May 12, 2016, which claims the benefit of Chinese Patent Application No. 201610076774.1, filed on Feb. 3, 2016, the entire disclosures of which are incorporated herein by reference.

### TECHNICAL FIELD

The present disclosure relates to the field of liquid crystal display technique, and particularly to a sealing agent, a liquid crystal panel, a liquid crystal display device, and a fabricating method thereof

### BACKGROUND

With development in technology, the liquid crystal panel is among display devices which have developed most fast due to its advantages like light weight and small thickness. The liquid crystal panel is formed by assembling an array substrate and a color filter substrate. A sealing agent acts as an adherent to bond the array substrate and the color filter substrate together.

As shown in FIG. 1, a common sealing agent comprises a sealing agent matrix 2 and an additive which has a function of supporting and electrically conducting. The sealing agent matrix 2 comprises a light curing resin, a thermal curing resin, a photo initiator, a thermal curing agent, an organic filling agent, a coupling agent, or the like. The additive comprises glass fiber (not shown) which has a function of supporting and gold particles 3 which have a function of electrically conducting.

### SUMMARY

Embodiments of the present disclosure provide a sealing agent, a liquid crystal panel based on the sealing agent, a liquid crystal display device, and a relating fabricating method, which can effectively prevent liquid crystal molecules penetration from occurring.

In a first aspect, embodiments of the present disclosure provide a sealing agent, which comprises a sealing agent matrix and graphene oxide.

In an embodiment, by taking 100% as the mass of the sealing agent, the graphene oxide has a mass fraction of about 2%-40%.

In an embodiment, the graphene oxide has a mass fraction of about 10%-19%.

In an embodiment, the graphene oxide has a sheet structure.

In an embodiment, the graphene oxide has a sheet dimension of about 6 μm-10 μm, and the graphene oxide has a sheet thickness of 1 nm (nanometer) or less.

In an embodiment, the sealing agent matrix comprises epoxy acrylic resin, acrylic resin, a thermal curing agent, a photo initiator, an organic filling agent, and a coupling agent.

In an embodiment, the sealing agent comprises components of the following mass fractions: graphene oxide, about 10%-19%; epoxy acrylic resin, about 20%-30%; acrylic resin, about 30%-35%; the thermal curing agent, about 10%-15%; the photo initiator, about 0.1%-0.5%; the organic filling agent, about 1%-6%; and the coupling agent, about 4%-4.5%.

In a second aspect, embodiments of the present disclosure provide a liquid crystal panel, comprising a color filter substrate and an array substrate, wherein the color filter substrate and the array substrate are bonded with each other by the sealing agent according to the first aspect of the present disclosure.

In a third aspect, embodiments of the present disclosure provide a liquid crystal display device, comprising the liquid crystal panel according to the second aspect of the present disclosure.

In a fourth aspect, embodiments of the present disclosure provide a method for fabricating a liquid crystal panel, comprises steps of:

step a, mixing a sealing agent matrix and graphene oxide uniformly to form a mixture;

step b, defoaming the mixture in a light-proof condition;

step c, coating the defoamed mixture from step b onto a frame of a color filter substrate; and

step d, assembling an array substrate on which liquid crystal is dropped and the color filter substrate from step c, and performing UV polymerization and thermal polymerization to form the liquid crystal panel.

In an embodiment, by taking 100% as the mass of the sealing agent, the graphene oxide has a mass fraction of about 2%-40%, and the sealing agent matrix has a mass fraction of about 60%-98%.

In an embodiment, the graphene oxide has a mass fraction of about 10%-19%, and the sealing agent matrix has a mass fraction of about 81%-90%.

In an embodiment, the graphene oxide has a sheet structure.

In an embodiment, the graphene oxide has a sheet dimension of about 6 μm-10 μm, and the graphene oxide has a sheet thickness of 1 nm or less.

In an embodiment, step a comprises stirring at a temperature of about 10° C.-30° C. for about 30 minutes-60 minutes, to uniformly mix the sealing agent matrix and the graphene oxide.

In an embodiment, the defoaming in step b lasts for about 1-5 hours.

### BRIEF DESCRIPTION OF THE DRAWINGS

The specific embodiments of the present disclosure shall be further described in the following text with reference to the figures and the embodiments. The following embodiments are only used for explaining more clearly the technical solution of the present disclosure rather than limiting the protection scope of the present disclosure.

FIG. 1 is a structural view for illustrating a sealing agent;

FIG. 2 is a structural view for illustrating a sealing agent in an embodiment of the present disclosure;

FIG. 3 is a schematic view for illustrating a process for fabricating graphene oxide;

FIG. 4 is a schematic view for illustrating a liquid crystal panel in which liquid crystal molecules penetration occurs; and

FIG. 5 is a flow chart for illustrating a method for fabricating a liquid crystal panel in an embodiment of the present disclosure.

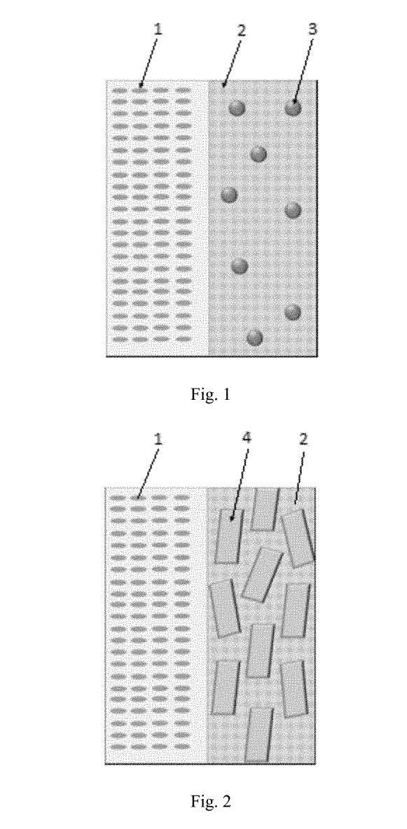

### DETAILED DESCRIPTION OF EMBODIMENTS

Unless otherwise defined, the technical or scientific terms used in the present invention shall have the general meanings understandable for those ordinarily skilled in the field of the present disclosure. The specific embodiments of the present disclosure shall be further described in the following text with reference to the figures and the embodiments. The following embodiments are only used for explaining more clearly the technical solution of the present disclosure rather than limiting the protection scope of the present disclosure.

Reference numerals: 1—liquid crystal molecules, 2—sealing agent matrix, 3—gold particle, 4—graphene oxide.

During realizing the present disclosure, the inventors found that the prior art at least suffers from the following problems. The glass fiber and gold particles are less compatible with other components in the sealing agent, so that the glass fiber and gold particles are not uniformly distributed in the sealing agent, and the supporting force is not uniform throughout the sealing agent, leading to the gap defect. In addition, the liquid crystal molecules between the array substrate and the color filter substrate tend to penetrate the sealing agent, and the phenomenon of liquid crystal molecules penetration occurs, which affects display effect of the liquid crystal panel.

In a first aspect, embodiments of the present disclosure provide a sealing agent. Referring to FIG. 2 which illustrates a part of the liquid crystal panel. As shown in FIG. 2, the sealing agent comprises a sealing agent matrix 2 and graphene oxide 4.

The graphene oxide is an oxide of graphene, which retains the sheet structure and conductivity of graphene, and has a relatively high hardness. Apart from this, a lot of hydrophilic groups are introduced in the graphene oxide molecule structure, so that the graphene oxide has excellent hydrophilic property.

Since the graphene oxide has a relatively high hardness and excellent conductivity, it can replace the conventional glass fiber and gold particles to realize the function of supporting substrates and electrically conducting, and effectively connecting the color filter substrate and the array substrate. Furthermore, the sheet structure of the graphene oxide effectively prevents small molecules from passing through, and effectively prevents the phenomenon of liquid crystal molecules penetration from occurring. Furthermore, since the graphene oxide has excellent hydrophilic property, and other components in the sealing agent are also hydrophilic, so that the graphene oxide can be uniformly distributed in the sealing agent, a uniform supporting force is provided throughout the sealing agent, and the gap defect is avoided. In this way, the phenomenon of liquid crystal molecules penetration due to non-uniform distribution of the conventional glass fiber and gold particles is prevented. In addition, the graphene oxide can increase viscosity of the sealing agent, which facilitates anchoring liquid crystal molecules and preventing penetration thereof. In view of these aspects, in embodiments of the present disclosure, the sealing agent can effectively prevent the phenomenon of liquid crystal molecules penetration from occurring, and the liquid crystal panel which is formed by taking the sealing agent as an adherent has excellent display effect. Apart from effectively preventing the phenomenon of liquid crystal molecules penetration, the sheet structure of the graphene oxide can prevent air and moisture from permeating into the liquid crystal panel, which ensures display effect of the liquid crystal panel. Furthermore, in the sealing agent according to an embodiment of the present disclosure, the content of graphene oxide affects the performance of preventing liquid crystal molecules penetration of the sealing agent. As the content of graphene oxide in the sealing agent increases, the viscosity of the sealing agent increases, the anchoring capability for liquid crystal molecules increases, and the effect of preventing liquid crystal molecules penetration also increases. However, in case the content of graphene oxide is too large, π-π interaction between molecules tends to induce aggregation of graphene oxide, which will cause defects and lead to liquid crystal molecules penetration. In view of this, the content of graphene oxide in the sealing agent is for example about 2%-40%, e.g., 4%, 5%, 6%, 8%, 10%, 12%, 14%, 15%, 16%, 18%, 19%, 20%, 22%, 24%, 25%, 26%, 28%, 30%, 32%, 34%, 35%, 36%, 38%. For example, the content of graphene oxide in the sealing agent is about 10%-19%.

Furthermore, in the sealing agent according to an embodiment of the present disclosure, the graphene oxide has a sheet structure. The sheet dimension and sheet thickness of the graphene oxide also have an effect on the performance of preventing liquid crystal molecules penetration of the sealing agent. In this context, the sheet dimension of the graphene oxide indicates an in-plane dimension of the sheet structure, e.g., the length of sides of the pattern like a parallelogram in FIG. 2. In order to ensure the performance of electrical conducting, supporting, and blocking of the sealing agent, the graphene oxide sheet contacts both the array substrate and the color filter substrate. The liquid crystal panel generally has a cell thickness of 2.5 μm-4.0 μm, and the graphene oxide may partially be folded in the sealing agent. Thus the graphene oxide for example has a sheet dimension about 6-10 μm, e.g., 6 μm, 6.5 μm, 7 μm, 7.5 μm, 8 μm, 8.5 μm, 9 μm, 9.5 μm, 10 μm, or the like. In case the graphene oxide has a too small sheet dimension, the graphene oxide can not contact the array substrate and the color filter substrate at the same time, which may affect the function of electrical conducting, supporting, and blocking of the sealing agent. In case the graphene oxide has a too large sheet dimension, the graphene oxide will be folded too much, which may affect the performance of the sealing agent. In embodiments of the present disclosure, the sheet dimension of the graphene oxide indicates a width of the graphene oxide sheet in at least one direction in the two-dimension space. The graphene oxide for example has a sheet thickness of 1 nm or less. In case the graphene oxide has a sheet thickness of 1 nm or less, it can be ensured that the graphene oxide is present in the form of a single sheet or 2 sheets. A too large sheet thickness indicates that aggregation possibly occurs, which thus affects the performance of the sealing agent.

Furthermore, in the sealing agent according to an embodiment of the present disclosure, there is no restriction to specific components of the sealing agent matrix. It will be appreciated by a person with ordinary skill in the art that the sealing agent matrix at least comprises epoxy acrylic resin, acrylic resin, a thermal curing agent, a photo initiator, an organic filling agent, and a coupling agent.

The epoxy acrylic resin is obtained from an reaction between epoxy resin and acrylic, which is a thermal curing resin and has the excellent properties of epoxy resin. The epoxy resin for reacting with acrylic to form the epoxy acrylic resin comprises bisphenol A type epoxy resin or phenolic type epoxy resin, e.g., epoxy resin under a brand of E21, E44, E51, F44, F51, or the like.

The acrylic resin is a resin which is formed by copolymerizing methacrylate, (methyl) acrylate monomers, and other alkene monomers. The acrylic resin molecule structure contain dual bonds, and upon UV irradiation, the photo initiator induces polymerization reaction of free radicals and thus induces curing. The (methyl) acrylate monomers for example comprise methyl methacrylate, ethyl methacrylate, propyl methacrylate, buutyl methacrylate, or the like, or the like. The other alkene monomers for example comprise styrene, α-methyl styrene, vinyl toluene, vinyl xylene, divinyl benzene, divinyl toluene, or the like, or the like.

The thermal curing agent for example is an amine curing agent. The thermal curing agent comprises, but not limited to, a fatty amine curing agent like ethylenediamine, diethylenetriamine, an aromatic amine curing agent like m-phenylene diamine, m-xylylenediamine, diaminodiphenyl-methane, or a modifying amine curing agent like β-ethoxyl ethylenediamine.

The photo initiator for example is a acetophenone photo initiator. The photo initiator comprises, but not limited to, acetophenone, 2,2-dimethoxyl-2-phenyl acetophenone, 2,2-diethoxyl-2-phenyl acetophenone, 1,1-dichloroacetophenone.

The organic filling agent modifies the physical and chemical properties of the sealing agent, such as shrinkage, expansion, resilience, to improve the ductility and bonding force. For example the organic filling agent comprises resin particles of a core-shell structure. The resin particle comprises a core which is made from a rubber elastic resin, and a shell which is made from a resin with a glass transition temperature of about 120-150° C. For example, polymers from acrylic monomers are used to fabricate resin particles with the above properties.

The coupling agent increases the bonding force between the sealing agent and the substrates, thus ensuring the bonding effect between the color filter substrate and the array substrate. The coupling agent for example comprises a silane coupling agent, e.g., vinyltrichlorosilane, triethoxyvinylsilane, ethenyltrimethoxysilane, trichlorophenylsilane, diphenyldimethoxysilane, 3-aminopropyltriethoxysilane, 3-aminopropyltriemethyl silane, methyldichlorosilane, methyldimethoxysilane, dimethyldichlorosilane, dimethyldimethoxysilane, dimethyldiethoxylsilane, or the like.

The specific types of the epoxy acrylic resin, the acrylic resin, the thermal curing agent, the photo initiator, the organic filling agent, and the silane coupling agent as described above are selected as necessary.

On basis of the foregoing, the sealing agent in an embodiment of the present disclosure for example comprises components of the following mass fractions:

graphene oxide, about 10%-19%;

epoxy acrylic resin, about 20%-30%;

acrylic resin, about 30%-35%;

thermal curing agent, about 10%-15%;

photo initiator, about 0.1%-0.5%;

organic filling agent, about 1%-6%; and

coupling agent, about 4%-4.5%.

The sealing agent with the above components and proportions has excellent bonding properties, so that the color filter substrate and the array substrate can be bonded firmly.

Besides, this sealing agent has excellent blocking properties, and can effectively prevent the phenomenon of liquid crystal molecules penetration from occurring, so that the liquid crystal panel has excellent display effect.

In a second aspect, embodiments of the present disclosure provide a liquid crystal panel. The liquid crystal panel comprises a color filter substrate and an array substrate. The color filter substrate and the array substrate are bonded by the sealing agent according to the first aspect of the present disclosure.

In the embodiment of the present disclosure, the color filter substrate and the array substrate of the liquid crystal panel are bonded with each other by the sealing agent containing graphene oxide. The graphene oxide not only has excellent supporting and conducting properties, but also has excellent blocking properties. The graphene oxide further has excellent compatibility with other components in the sealing agent, and can be uniformly distributed in the sealing agent. Thus, the liquid crystal panel in embodiments of the present disclosure will not suffer from the phenomenon of liquid crystal molecules penetration, and has excellent display effect.

In a third aspect, embodiments of the present disclosure provide a liquid crystal display device, which comprises the liquid crystal panel according to the second aspect of the present disclosure.

Since the liquid crystal panel as described above has excellent display effect, the liquid crystal display device comprising such a liquid crystal panel also has excellent display effect.

In a fourth aspect, embodiment of the present disclosure provide a method for fabricating a liquid crystal panel, comprising steps of:

step a, mixing a sealing agent matrix and graphene oxide uniformly to form a mixture;

step b, defoaming the mixture in a light-proof condition;

step c, coating the defoamed mixture from step b onto a frame of a color filter substrate; and

step d, assembling an array substrate on which liquid crystal is dropped and the color filter substrate from step c, and performing UV polymerization and thermal polymerization to form the liquid crystal panel.

In this method, the sealing agent by which the color filter substrate and the array substrate are bonded with each other contains graphene oxide. The graphene oxide not only has excellent supporting and conducting properties, but also has excellent blocking properties. The graphene oxide further has excellent compatibility with other components in the sealing agent, and can be uniformly distributed in the sealing agent. Thus, the liquid crystal panel formed by this method will not suffer from the phenomenon of liquid crystal molecules penetration, and has excellent display effect.

Furthermore, in the above method, by taking 100% as the mass of the sealing agent, the graphene oxide for example has a mass fraction of about 2%-40%, or about 10%-19%; and the sealing agent matrix for example has a mass fraction of about 60%-98%, or about 81%-90%.

Furthermore, in the above method, the graphene oxide for example has a sheet dimension of about 6 μm-10 μm, and a sheet thickness of 1 nm or less.

Furthermore, in the above method, for the purpose that the graphene oxide and the sealing agent matrix are mixed uniformly to ensure the display effect of the finished liquid crystal panel, mixing the graphene oxide and the sealing agent matrix in step a is for example performed under the following conditions: stirring at a temperature of about 10° C.-30° C. for about 30 minutes-60 minutes. The temperature for example is 15° C., 20° C., 25° C., or the like, The duration for stirring for example is 35 minutes, 40 minutes, 45 minutes, 50 minutes, 55 minutes, or the like.

Furthermore, in the above method, the defoaming in step b for example has a duration of about 1-5 hours, e.g., 1.5 hours, 2 hours, 2.5 hours, 3 hours, 3.5 hours, 4 hours, 4.5 hours, or the like.

The present disclosure will be described in detail hereinafter by referring to specific examples.

In the following examples, unless otherwise indicated, the related operations are performed under the conventional conditions or the conditions suggested by relevant manufacturers. The following raw materials the manufacturer and specification of which are not indicated are available from the market.

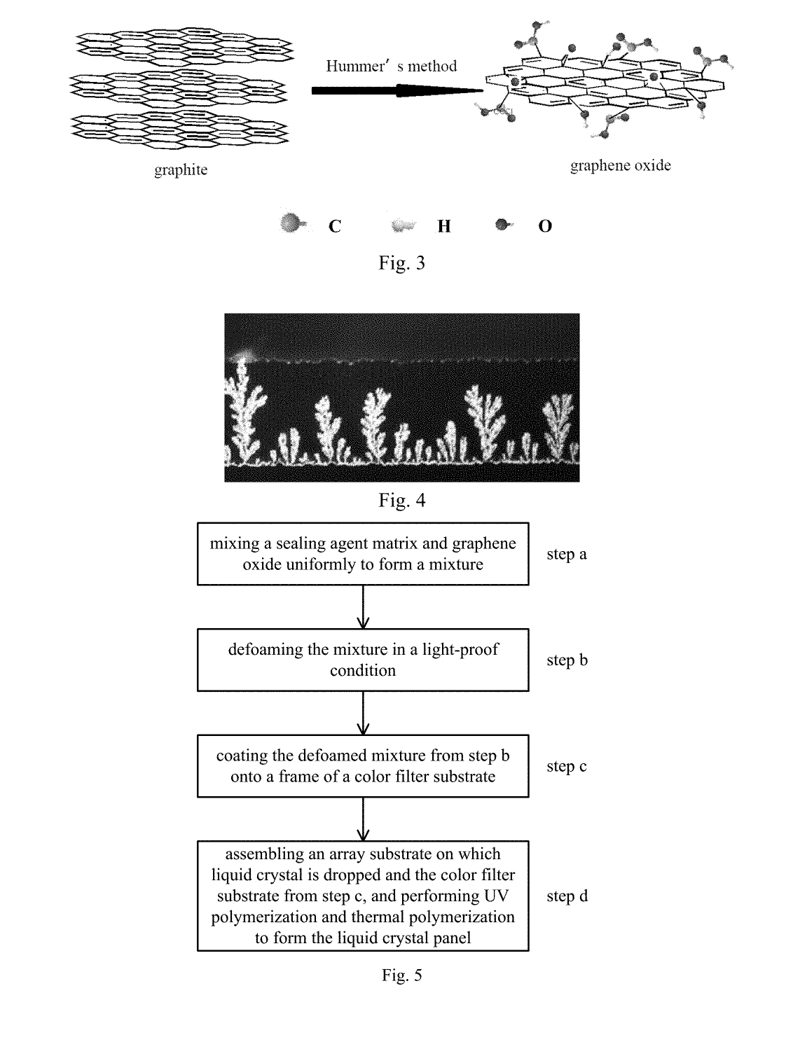

The following examples 1-6 and comparative examples 1-5 adopt graphene oxide which is prepared by the modified Hummer's method. Referring to FIG. 3, the preparing process is described as follow.

3 g graphite powder and 1.5 g NaNO₃ are mixed uniformly. The mixture of graphite powder and NaNO₃ is added with 69 ml concentrated sulfuric acid slowly, stirred uniformly, and then further added with 9 g KMnO₄ slowly. In the above process, the temperature is kept not higher than 20° C. After adding KMnO₄, the mixture is stirred for 2 hours. The above reaction mixture is transferred to a water bath at 35° C., stirred for 1 hour, and added with 138 ml deionized water. The temperature of the water bath is gradually increased to 98° C. During increase in temperature, the reaction product is moved out of the water bath when it changes its color to golden yellow. The product is then stirred and added with 30 ml H₂O₂. The product is rinsed with diluted hydrochloric acid (with a volume ratio of 1:10) for three times, and then with clean water for several times. The product is then dialyzed until it has a pH value of about 5. The product is dried at 50° C. into graphene oxide.

The sheet dimension of graphene oxide is determined by that of the graphite powder as the raw material.

The graphene oxide can also be prepared by other methods or be directly available from the market, provided that the graphene oxide has a sheet dimension and a sheet thickness which meet the requirements in the examples and comparative examples.

### EXAMPLE 1

The present example provides a sealing agent, which comprises components of the following mass fractions:

graphene oxide, 2%;

epoxy acrylic resin, 25%;

acrylic resin, 48%;

diaminodiphenyl-methane, 15%;

acetophenone, 0.5%;

organic filling agent, 5%; and

triethoxyvinylsilane, 4.5%.

In the present example, the graphene oxide has a sheet dimension of 6 μm and a sheet thickness of about 1 nm.

It is appreciated by the person with ordinary skill in the art that the sheet dimension of the prepared graphene oxide does not refer to an absolute value, but to a range. For example, in the graphene oxide prepared by the above method, most sheets (50% or more) can be controlled to have a dimension in a range of about 6 μm.

### EXAMPLE 2

The present example provides a sealing agent, which comprises components of the following mass fractions:

graphene oxide, 10%;

epoxy acrylic resin, 30%;

acrylic resin, 35%;

diaminodiphenyl-methane, 15%;

acetophenone, 0.5%;

organic filling agent, 5%; and

triethoxyvinylsilane, 4.5%.

In the present example, the graphene oxide has a sheet dimension of 7 μm and a sheet thickness of about 1 nm.

### EXAMPLE 3

The present example provides a sealing agent, which comprises components of the following mass fractions:

graphene oxide, 12%;

epoxy acrylic resin, 30%;

acrylic resin, 35%;

diaminodiphenyl-methane, 14%;

acetophenone, 0.5%;

organic filling agent, 4.5%; and

triethoxyvinylsilane, 4%.

In the present example, the graphene oxide has a sheet dimension of 8 μm and a sheet thickness of about 1 nm.

### EXAMPLE 4

The present example provides a sealing agent, which comprises components of the following mass fractions:

graphene oxide, 16%;

epoxy acrylic resin, 28%;

acrylic resin, 32%;

diaminodiphenyl-methane, 15%;

acetophenone, 0.5%;

organic filling agent, 4.5%; and

triethoxyvinylsilane, 4%.

In the present example, the graphene oxide has a sheet dimension of 9 μm and a sheet thickness of about 1 nm.

### EXAMPLE 5

The present example provides a sealing agent, which comprises components of the following mass fractions:

graphene oxide, 19%;

epoxy acrylic resin, 25%;

acrylic resin, 35%;

diaminodiphenyl-methane, 12%;

acetophenone, 0.5%;

organic filling agent, 4.5%; and

triethoxyvinylsilane, 4%.

In the present example, the graphene oxide has a sheet dimension of 10 μm and a sheet thickness of about 1 nm.

### EXAMPLE 6

The present example provides a sealing agent, which comprises components of the following mass fractions:

graphene oxide, 40%;

epoxy acrylic resin, 18%;

acrylic resin, 23%;

diaminodiphenyl-methane, 10%;

acetophenone, 0.5%;

organic filling agent, 4.5%; and

triethoxyvinylsilane, 4%.

In the present example, the graphene oxide has a sheet dimension of 8 μm and a sheet thickness of about 1 nm.

### COMPARATIVE EXAMPLE 1

The present comparative example provides a sealing agent, and differs from example 5 in that the graphene oxide has a lower mass fraction. The mass fractions of components are listed as follow:

graphene oxide, 0.5%;

epoxy acrylic resin, 35%;

acrylic resin, 45%;

diaminodiphenyl-methane, 10%;

acetophenone, 0.5%;

organic filling agent, 5%; and

triethoxyvinylsilane, 4%.

In the present comparative example, the graphene oxide has a sheet dimension of 10 μm and a sheet thickness of about 1 nm.

### COMPARATIVE EXAMPLE 2

The present comparative example provides a sealing agent, and differs from example 5 in that the graphene oxide has a higher mass fraction. The mass fractions of components are listed as follow:

graphene oxide, 50%;

epoxy acrylic resin, 15%;

acrylic resin, 20%;

diaminodiphenyl-methane, 6%;

acetophenone, 0.5%;

organic filling agent, 4.5%; and

triethoxyvinylsilane, 4%.

In the present example, the graphene oxide has a sheet dimension of 10 μm and a sheet thickness of about 1 nm.

### COMPARATIVE EXAMPLE 3

The present comparative example provides a sealing agent, which has the same components and proportions as example 5. The graphene oxide has a sheet dimension of 2 μm and a sheet thickness of about 1 nm.

### COMPARATIVE EXAMPLE 4

The present comparative example provides a sealing agent, which has the same components and proportions as example 5. The graphene oxide has a sheet dimension of 20 μm and a sheet thickness of about 1 nm.

### COMPARATIVE EXAMPLE 5

The present comparative example provides a sealing agent, which has the same components and proportions as example 5. The graphene oxide has a sheet dimension of 10 μm and a sheet thickness of about 5 nm.

### COMPARATIVE EXAMPLE 6

The present comparative example provides a sealing agent. The present comparative example differs from example 5 in that, the present comparative example adopts glass fiber as the supporting agent and gold particles as the conducting agent. The mass fractions of components are listed as follow:

glass fiber, 10%;

gold particles, 9%;

epoxy acrylic resin, 25%;

acrylic resin, 35%;

diaminodiphenyl-methane, 12%;

acetophenone, 0.5%;

organic filling agent, 4.5%; and

triethoxyvinylsilane, 4%.

In the present comparative example, the graphene oxide has a sheet dimension of 10 μm and a sheet thickness of about 1 nm.

### EXAMPLE 7

The present example prepares a liquid crystal panel with the sealing agent of the above examples 1-6 and comparative examples 1-6. The method comprises the following steps:

step 1, according to recipes of the above examples 1-6 and comparative examples 1-6, stirring at 25° C. for 60 minutes so that component are mixed uniformly to form a mixture;

step 2, defoaming the mixture resulting from step 1 in a light-proof condition for 5 hours;

step 3, coating the defoamed mixture resulting from step 2 onto a frame of a color filter substrate;

step 4, assembling an array substrate on which liquid crystal is dropped and the color filter substrate resulting from step 3, and performing UV polymerization and thermal polymerization to form a liquid crystal panel.

### EXAMPLE 8

In the present example, the distribution of graphene oxide in the sealing agent in the liquid crystal panel from example 7 is observed, and the results follow.

In the liquid crystal panel formed by the sealing agent from examples 1-6, the graphene oxide is distributed uniformly in the sealing agent, has a multiple-layered structure, and is arranged regularly. The sealing agent are arranged homogenously as a whole, and there is no gap defect. The graphene oxide contacts both the color filter substrate and the array substrate.

In the liquid crystal panel formed by the sealing agent from comparative example 1, although the graphene oxide is also distributed uniformly in the sealing agent, there is a relatively large gap between graphene oxide due to the low content of graphene oxide.

In the liquid crystal panel formed by the sealing agent from comparative example 2, since graphene oxide content is too high, graphene oxide aggregates and is not uniformly distributed in the sealing agent, and there is a gap defect in the sealing agent.

In the liquid crystal panel formed by the sealing agent from comparative example 3, graphene oxide is distributed relatively uniformly in the sealing agent, graphene oxide does not contact both the array substrate and the color filter substrate due to the relatively small sheet dimension of the graphene oxide.

In the liquid crystal panel formed by the sealing agent from comparative example 4, graphene oxide is distributed relatively uniformly in the sealing agent, and contacts both the array substrate and the color filter substrate. However, due to the relatively large sheet dimension of the graphene oxide, the graphene oxide is folded to a large extent.

In the liquid crystal panel formed by the sealing agent from comparative example 5, since graphene oxide has a too large sheet thickness, graphene oxide aggregates, in the sealing agent non-uniform distribution, there is a gap defect in the sealing agent.

In the liquid crystal panel formed by the sealing agent from comparative example 6, the glass fiber and gold particles are not uniformly distributed in the sealing agent, and there is a gap defect in the sealing agent.

### EXAMPLE 9

In the present example, the phenomenon of liquid crystal molecules penetration in the liquid crystal panel prepared with the sealing agent from the above examples 1-6 and comparative examples 1-6 is inspected. The inspecting method is described as follow.

A liquid crystal panel is prepared according to the method of example 7, and the liquid crystal molecules are used to the upper limit. The assembled liquid crystal panel is inspected with a visual apparatus to determine whether liquid crystal molecules penetration occurs in the liquid crystal panel. As shown in FIG. 4, in a liquid crystal panel in which liquid crystal molecules penetration occurs, bright spots with a sawtooth shape appears at the frame.

The sealing agent from each of the examples (or comparative examples) is used to prepare liquid crystal panels under the same processing conditions, and the percentage of liquid crystal panels in which liquid crystal molecules penetration occurs is evaluated.

The evaluation results follow.

In the liquid crystal panels prepared with the sealing agent from examples 2 -4, liquid crystal panel liquid crystal molecules penetration does not occurs.

In the liquid crystal panels prepared with the sealing agent from example 1 and example 6, the phenomenon of liquid crystal molecules penetration occurs in about 0.5% of the liquid crystal panels.

In the liquid crystal panels prepared with the sealing agent from comparative example 1 and comparative examples 3-5, the phenomenon of liquid crystal molecules penetration occurs in about 10% of the liquid crystal panels.

In the liquid crystal panel formed by the sealing agent from comparative example 6, the phenomenon of liquid crystal molecules penetration occurs in about 20% of the liquid crystal panels.

The sealing agent from comparative example 2 has a too large content of graphene oxide, and in the liquid crystal panel formed by the sealing agent from comparative example 2, the phenomenon of liquid crystal molecules penetration occurs in about 30% of the liquid crystal panels.

In embodiments of the present disclosure, the sealing agent comprises graphene oxide. The graphene oxide has a relatively high hardness and excellent conductivity, so that it can replace the conventional glass fiber and gold particles to realize the function of supporting substrates and electrical conducting. In addition, the graphene oxide has excellent hydrophilic property, and other components of the sealing agent are also hydrophilic. As a result, the graphene oxide can be uniformly distributed in the sealing agent, so that a uniform supporting force is provided throughout the sealing agent, and a gap defect is avoided. In this way, the phenomenon of liquid crystal molecules penetration due to non-uniform distribution of the conventional glass fiber and gold particles is prevented.

Besides, the graphene oxide has a sheet structure and forms a multiple-layered structure in the sealing agent, which effectively prevents small molecules from passing through, and thus effectively prevents the phenomenon of liquid crystal molecules penetration from occurring. Furthermore, the graphene oxide can increase viscosity of the sealing agent, which facilitates anchoring liquid crystal molecules and preventing penetration thereof. In view of these aspects, the sealing agent in embodiments of the present disclosure can effectively prevent the phenomenon of liquid crystal molecules penetration from occurring, and thus ensures display effect of the liquid crystal panel.

In summary, embodiments of the present disclosure provide a sealing agent, a liquid crystal panel, a liquid crystal display device, and a fabricating method thereof. The graphene oxide replaces the conventional glass fiber and gold particles in the sealing agent, which effectively prevents the phenomenon of liquid crystal molecules penetration from occurring, prevents bright spots with a sawtooth shape at the frame of the liquid crystal panel due to liquid crystal molecules penetration, thus ensures the display effect of the liquid crystal panel and the liquid crystal display device.

Apparently, the person with ordinary skill in the art can make various modifications and variations to the present disclosure without departing from the spirit and the scope of the present disclosure. In this way, provided that these modifications and variations of the present disclosure belong to the scopes of the claims of the present disclosure and the equivalent technologies thereof, the present disclosure also intends to encompass these modifications and variations.

1. A sealing agent, comprising a sealing agent matrix, wherein the sealing agent further comprises graphene oxide.

2. The sealing agent of claim 1, wherein, by taking 100% as the mass of the sealing agent, the graphene oxide has a mass fraction of about 2%-40%.

3. The sealing agent of claim 2, wherein the graphene oxide has a mass fraction of about 10%-19%.

4. The sealing agent of claim 1, wherein the graphene oxide has a sheet structure.

5. The sealing agent of claim 4, wherein the graphene oxide has a sheet dimension of about 6-10 μm.

6. The sealing agent of claim 1, wherein the sealing agent matrix comprises epoxy acrylic resin, acrylic resin, a thermal curing agent, a photo initiator, an organic filling agent, and a coupling agent.

7. The sealing agent of claim 6, wherein the sealing agent comprises components of the following mass fractions: graphene oxide, about 10%-19%; epoxy acrylic resin, about 20%-30%; acrylic resin, about 30%-35%; the thermal curing agent, about 10%-15%; the photo initiator, about 0.1%-0.5%; the organic filling agent, about 1%-6%; and the coupling agent, about 4%-4.5%.

8. A liquid crystal panel, comprising a color filter substrate and an array substrate, wherein the color filter substrate and the array substrate are bonded with each other by a sealing agent, wherein the sealing agent comprises a sealing agent matrix and graphene oxide.

9. A liquid crystal display device, comprising the liquid crystal panel of claim 8.

10. A method for fabricating a liquid crystal panel, comprising steps of:
step a, mixing a sealing agent matrix and graphene oxide uniformly to form a mixture;
step b, defoaming the mixture in a light-proof condition;
step c, coating the defoamed mixture from step b onto a frame of a color filter substrate; and
step d, assembling an array substrate on which liquid crystal is dropped and the color filter substrate from step c, and performing UV polymerization and thermal polymerization to form the liquid crystal panel.

11. The method of claim 10, wherein by taking 100% as the mass of the sealing agent, the graphene oxide has a mass fraction of about 2%-40%, and the sealing agent matrix has a mass fraction of about 60%-98%.

12. The method of claim 11, wherein the graphene oxide has a mass fraction of about 10%-19%, and the sealing agent matrix has a mass fraction of about 81%-90%.

13. The method of claim 10, wherein the graphene oxide has a sheet structure.

14. The method of claim 13, wherein the graphene oxide has a sheet dimension of about 6 μm-10 μm.

15. The method of claim 10, wherein step a comprises stirring at a temperature of about 10° C.-30° C. for about 30 minutes-60 minutes, to uniformly mix the sealing agent matrix and the graphene oxide.

16. The method of claim 10, wherein the defoaming in step b lasts for about 1-5 hours.

17. The sealing agent of claim 5, wherein the graphene oxide has a sheet thickness of 1 nm or less.

18. The method of claim 14, wherein the graphene oxide has a sheet thickness of 1 nm or less.
